(19) United States
(12) Patent Application Publication
(10) Pub. No.: US 2009/0083762 A1
(43) Pub. Date: Mar. 26, 2009

(54) Dynamically mapping an action of a message

(75) Inventors: Andrew L. Luty, Redmond, WA (US); John A. Taylor, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/903,636

(22) Filed: Sep. 24, 2007

(51) Int. Cl. G06F 13/00

(52) U.S. Cl. 719/314

(57) ABSTRACT

A system and method for dynamically mapping an action of a message is disclosed. The technology initially receives a first message generated by a first Service Oriented Architecture (SOA). The first message comprises an operation which is described within the message context of the first message. It is then determined that the operation corresponds to an action of a second SOA. A second message is then generated which is compatible with the second SOA. The second message comprises metadata which describes the action of the second SOA.

### BACKGROUND

Service Oriented Architecture (SOA) refers to an evolving technology which is increasingly implemented for building distributed computing systems. A service in the context of an SOA is typically defined as a functionality which is exposed to other nodes. A typical SOA collects discreet services into a single logical application. In other words, the services can be implemented as building blocks to form an ad-hoc application from existing software applications. The services can be local or remote and a single node in an SOA can act as both a client and as a service for another client in the SOA.

Typically, an SOA is implemented using Web Services which facilitate accessing a local application via the Internet. In other words, Web Services allow the exchange of data between different services of an SOA. Using Web Services, a service endpoint can publish the function of an application to other nodes of the SOA by sending a message which describes the location of a service and the functionality performed by that service. Typically, a service is called when a message invoking the operation is received. For example, the message may specify a given operation in the message header.

However, when integrating various platforms, differences in how they operate can hinder integrating those platforms. For example, the communication system of one SOA uses a code generation tool to generate a proxy for each client which is interacting with a service. Thus, the proxy forwards a call to a service rather than the client itself. Each service method being called by a proxy is specifically described in the header of the message sent by the proxy. However, another communication system may not generate code. This prevents a dispatcher on the service from being able to invoke the correct service method. For example, the communication system of another SOA may generate schemas and port types that correspond to service methods described above. From the schemas that are generated, there is no direct way to tell which action is being requested based upon a particular schema/message type.

### SUMMARY

This Summary is provided to introduce a selection of concepts in form that are further described below in the Detailed Description. This Summary is not to be used as an aid in determining the scope of the claimed subject matter.

A system and method for dynamically mapping an action of a message is disclosed. The technology initially receives a first message generated by a first Service Oriented Architecture (SOA). The first message comprises an operation which is described within the message context of the first message. It is then determined that the operation corresponds to an action of a second SOA. A second message is then generated which is compatible with the second SOA. The second message comprises metadata which describes the action of the second SOA.

Furthermore, the present technology uses a mapping which correlates an operation of a first SOA with an action of a second SOA. This mapping can be automatically created based upon a WSDL message generated by the second SOA. When a first message is received from the first SOA, the mapping is accessed to determine which action of the second SOA corresponds to the operation being invoked by the first SOA. A second message is then generated in which an action is described in a SOAP header of the second message which corresponds to the action being requested of the second SOA.

### DESCRIPTION OF THE DRAWINGS

The accompanying drawings, which are incorporated in and form a part of this specification, illustrate embodiments of the technology for dynamically mapping an action of a message and, together with the description, serve to explain principles discussed below:

FIG. 1 is a diagram of an exemplary computer system used in accordance with embodiments of the present technology for dynamically mapping an action of a message.

FIG. 2 is a flowchart of a method for dynamically mapping an action of a message in accordance with one embodiment of the present technology.

FIG. 3 is a block diagram of a communication network in accordance with one embodiment of the present technology.

FIG. 4 is a block diagram showing in greater detail the dynamic mapping an action of a message in accordance with one embodiment of the present technology.

FIG. 5 is a block diagram of a dynamic message mapping system in accordance with one embodiment of the present technology.

### DETAILED DESCRIPTION

Reference will now be made in detail to embodiments of the present technology for dynamically mapping an action of a message, examples of which are illustrated in the accompanying drawings. While the technology for dynamically mapping an action of a message will be described in conjunction with various embodiments, it will be understood that they are not intended to limit the present technology for dynamically mapping an action of a message to these embodiments. On the contrary, the presented technology for dynamically mapping an action of a message is intended to cover alternatives, modifications and equivalents, which may be included within the spirit and scope the various embodiments as defined by the appended claims.

Furthermore, in the following detailed description, numerous specific details are set forth in order to provide a thorough understanding of the present technology for dynamically mapping an action of a message. However, the present technology for dynamically mapping an action of a message may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving”, “determining”, “generating”, “correlating”, “selecting”, “sending”, “using”, “conveying” or the like, refer to the actions and processes of a computer system, or similar electronic computing device. The computer system, or similar electronic computing device, manipulates and transforms data represented as physical (electronic) quantities within the computer system's registers and memories into other data similarly represented as physical quantities within the computer system memories or registers or other such information storage, transmission, or display devices. The present technology for dynamically mapping an action of a message is also well suited to the use of other computer systems such as, for example, optical and mechanical computers.

### Example Computer System Environment

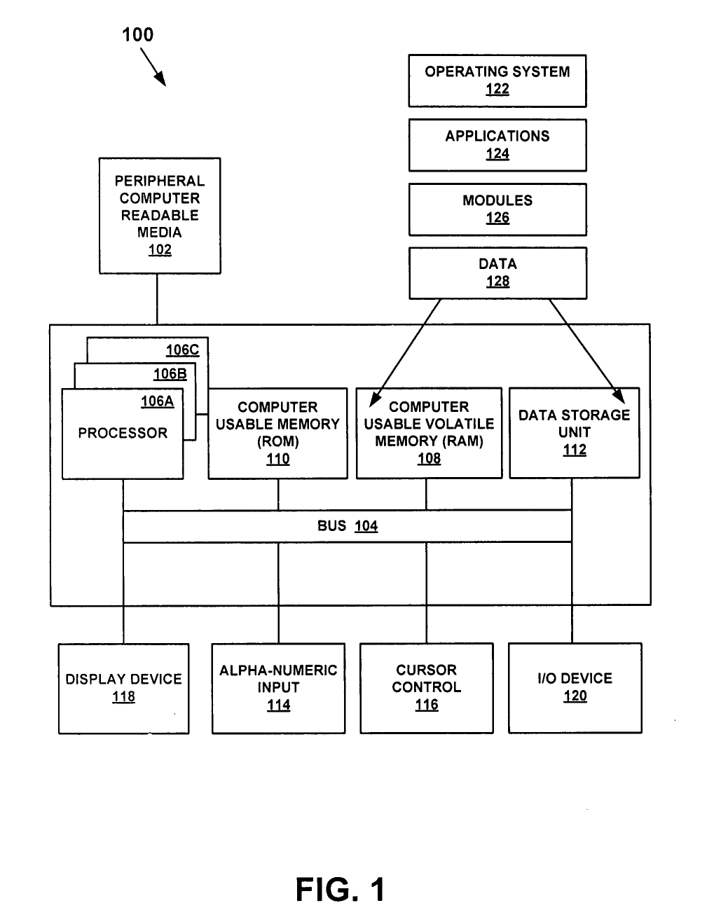

With reference now to FIG. 1, portions of the technology for dynamically mapping an action of a message are composed of computer-readable and computer-executable instructions that reside, for example, in computer-usable media of a computer system. That is, FIG. 1 illustrates one example of a type of computer that can be used in at least one embodiment, which is discussed below, of the present technology for dynamically mapping an action of a message.

FIG. 1 illustrates an exemplary computer system 100 used in accordance with embodiments of the present technology for dynamically mapping an action of a message. It is appreciated that system 100 of FIG. 1 is exemplary only and that the present technology for dynamically mapping an action of a message can operate on or within a number of different computer systems including general purpose networked computer systems, embedded computer systems, routers, switches, server devices, consumer devices, various intermediate devices/artifacts, stand alone computer systems, and the like. As shown in FIG. 1, computer system 100 of FIG. 1 is well adapted to having peripheral computer readable media 102 such as, for example, a floppy disk, a compact disc, and the like coupled thereto.

System 100 of FIG. 1 includes an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, such as random access memory (RAM), coupled to bus 104 for storing information and instructions for processors 106A, 106B, and 106C.

System 100 also includes computer usable non-volatile memory 110, such as read only memory (ROM), coupled to bus 104 for storing static information and instructions for processors 106A, 106B, and 106C. Also present in system 100 is a data storage unit 112 (for example, a magnetic or optical disk and disk drive) coupled to bus 104 for storing information and instructions. System 100 also includes an optional alphanumeric input device 114 coupled to bus 104 for communicating information and command selections to processor 106A or processors 106A, 106B, and 106C. System 100 also includes an optional cursor control device 116 coupled to bus 104 for communicating user input information and command selections to processor 106A or processors 106A, 106B, and 106C. System 100 of the present embodiment also includes an optional display device 118 coupled to bus 104 for displaying information.

Referring still to FIG. 1, optional display device 118 of FIG. 1 may be a liquid crystal device, cathode ray tube, plasma display device or other display device suitable for creating graphic images and alphanumeric characters recognizable to a user. Optional cursor control device 116 allows the computer user to dynamically signal the movement of a visible symbol (cursor) on a display screen of display device 118. Many implementations of cursor control device 116 are known in the art including a trackball, mouse, touch pad, joystick, or keys on alpha-numeric input device 114 capable of signaling movement of a given direction or manner of displacement.

System 100 is also well suited to having a cursor directed by other means such as, for example, voice commands. System 100 also includes an I/O device 120 for coupling system 100 with external entities. For example, in one embodiment, I/O device 120 is a modem for enabling wired or wireless communications between system 100 and an external network such as, but not limited to, the Internet. A more detailed discussion of the present technology for dynamically mapping an action of a message is found below.

Referring still to FIG. 1, various other components are depicted for system 100. Specifically, when present, an operating system 122, applications 124, modules 126, and data 128 are shown as typically residing in one or some combination of computer usable volatile memory 108, and data storage unit 112. In one embodiment, the present technology for dynamically mapping an action of a message, for example, is stored as an application 124 or module 126 in RAM memory locations within computer usable volatile memory 108 and memory areas within data storage unit 112.

The computing system 100 is only one example of a suitable computing environment and is not intended to suggest any limitation as to the scope of use or functionality of the present technology. However the above description is not meant to limit implementation of the present technology to a particular combination of components illustrated in the exemplary computing system 100.

The present technology is operational with numerous other general-purpose or other computer environments or configurations. Examples of well known computing systems, environments, and configurations that may be suitable for use with the present technology include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

The present technology may be described in the general context of computer-executable instructions, such as program modules, resident on a computer-usable medium which are executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

### Overview

One embodiment of the present technology creates a mapping between an operation of a first SOA and an action of a second SOA. For example, a message (e.g., a WSDL message) is received from the second SOA and a mapping is created which correlates an operation of the first SOA with an action of the second SOA. When a message is generated by the first SOA, the message is accessed and a determination is made of which action of the second SOA corresponds with the operation being called by the first SOA. A second message is then generated which is compatible with the second SOA in which the action being called by the first SOA is conveyed. The second message is a SOAP compatible message and the action being called is described in metadata conveyed in the header of the SOAP message generated by the present technology. In so doing, the present technology can facilitate exchanging messages between SOAs which use different communication systems. Additionally, a mapping can be created which correlates an operation of the second SOA with an action being invoked by the first SOA. More specifically, the present technology can be used to facilitate communication between procedural based implementations (e.g., XLANG), which identify methods by operation name, and message based implementations (e.g., web services) where methods are identified by an action.

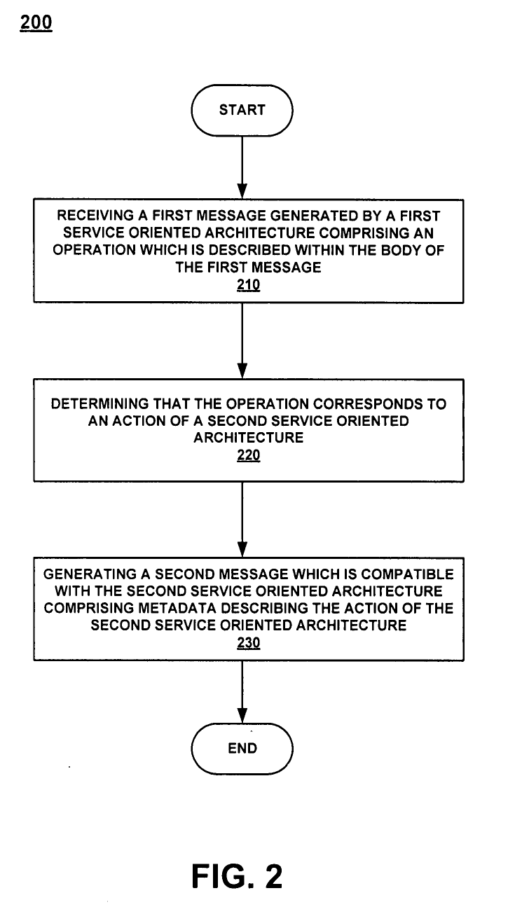

FIG. 2 is a flowchart of a method 200 for dynamically mapping an action of a message in accordance with one embodiment of the present technology. In operation 210 of FIG. 2, a first message is received which was generated by a first SOA. Furthermore, the first message comprises a description of an operation within the message context of the first message.

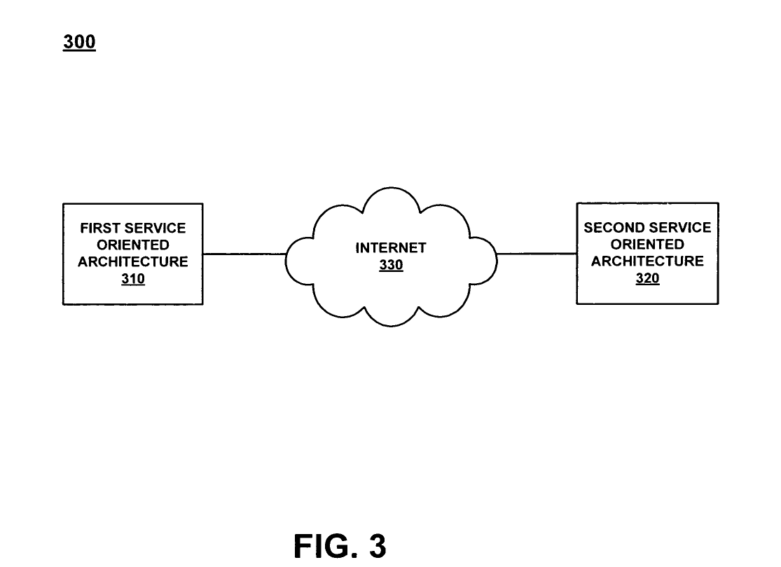

Referring now to FIG. 3, a first SOA (e.g., first SOA 310 of FIG. 3) generates a first message for invoking an action by a second SOA (e.g., second SOA 320 of FIG. 3). Typically, the Web Services use the Extensible Markup Language (XML) to code and decode data and the Simple Object Access Protocol (SOAP) as the communication protocol for sending messages. In one embodiment, the operation being invoked by a node in the SOA is described in the SOAP header of a message generated by the node invoking the service. In the present example, the first message is a request for second SOA to perform an action and is conveyed to second SOA 320 via Internet 330. However, the first message may be conveyed by other known communication networks as well. As will be described in greater detail below, first SOA 310 utilizes a different communication system than that used by second SOA 320. For example, a message generated by first SOA 310 comprises a message context and a message body which are considered independent message parts of a multi-part message. The message context comprises property values (e.g., name/property value pairs) which are extracted from, or are related to the message itself. In one embodiment, first SOA 310 conveys a request for an operation in the message context of a generated message rather than in the header of a SOAP message. As a result, second SOA 320 may not be able to determine which operation is being invoked by first SOA 310 if the first message remains in its present configuration because the operation is not specified in the header of a SOAP message.

With reference to operation 220 of FIG. 2, it is determined that the operation described within the message context of the first message corresponds to an action of a second SOA. As will be described in greater detail below, one embodiment of the present technology correlates an operation being invoked by the first SOA with an action which can be performed by the second SOA.

With reference to operation 230 of FIG. 2, a second message is generated which is compatible with the second SOA and which comprises metadata describing the action of the second SOA. One embodiment of the present technology conveys the action being invoked by the first SOA in the header of the second message. For example, the second SOA utilizes SOAP messages in which the invoked action is described in metadata disposed within the message header.

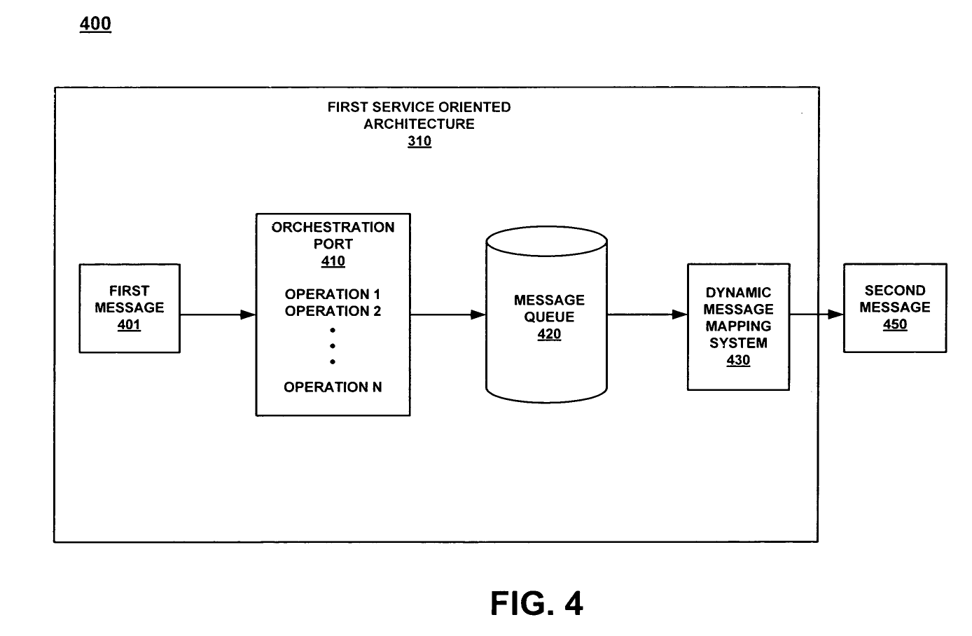

FIG. 4 is a block diagram showing in greater detail dynamically mapping an action of a message in accordance with one embodiment of the present technology. In FIG. 4, a first message 401 is generated by first SOA 310. For the purposes of the present discussion, first message 401 does not comprise header information which can invoke an action in second SOA 320 of FIG. 3. Instead, as described above, the action being invoked by first SOA 310 is disposed in the message context of first message 401. In the present example, first SOA 310 utilizes a communication system in which endpoints in first SOA 310 send information and requests for services in the SOA. Typically, the messages sent in first SOA 310 are addressed to a specific port which is associated with the service being invoked.

In the present example, first SOA 310 sends first message 401 via orchestration pot 410. In one embodiment, orchestration port 410 is created to be used with a particular service of second SOA 320. Orchestration port 410 is configured with one operation which is correlated with a corresponding method which can be invoked on a particular service of second SOA 320. Depending upon which operation is being invoked by first SOA 310, the message context of first message 401 will be appended with the port operation (e.g., operation 1, operation 2, operation N) through which it was sent. In other words, when an operation is defined on orchestration port 410, a message passing through that port will be appended with that operation. First message 401 then enters message queue 420.

Dynamic message mapping system 430 then accesses first message 401 from message queue 420. In one embodiment, dynamic message mapping system 430 comprises software instructions resident upon, for example, computer system 100 of FIG. 1. Dynamic message mapping system 430 may also comprise hardware and/or firmware components, or any combination thereof. Dynamic message mapping system 430 typically comprises a component of an adapter (not shown) which facilitates communication between first SOA 310 and second SOA 320. For example, the adapter may be running upon a computer of first SOA 310 as a client of second SOA 320.

Dynamic message mapping system 430 accesses a mapping between an operation being invoked by first SOA 310 and a corresponding action to be performed by second SOA 320. The following XML description of a lookup table shows a mapping between an operation being invoked by first SOA 310 and a corresponding action to be performed by second SOA 320 in accordance with one embodiment of the present technology:

Sample Mapping 1

<ActionMapping>

<Operation Name= “Operation1” Action= “Action 1”/>
<Operation Name= “Operation2” Action= “Action 2”/>
<Operation Name= “OperationN” Action= “Action 3”/>
<Operation Name= “OperationN” Action= “Action 4”/>

</ActionMapping>

As shown above, if first message 401 is appended with Operation 1, dynamic message mapping system 430 determines that a corresponding Action 1 is to be invoked on second SOA 320. Similarly, if first message 401 is appended with Operation 2, dynamic message mapping system 430 determines that a corresponding Action 2 is to be invoked on second SOA 320. As shown above, an operation (e.g., Operation N) can be mapped to more than one corresponding action in second SOA (e.g., Action 3 and/or Action 4). In one embodiment, Operation1, Operation2, and OperationN are described in the message context of first message 401. The mapping between an operation of first SOA 310 and a corresponding action of second SOA 320 can be created automatically from the WSDL document describing the service of second SOA 320. It is noted that the mapping shown above can also be manually created and/or configured.

It is noted that the mapping process as described above is reversible as well. That is, a mapping can be created in which an operation of first SOA 310 can be mapped to an action being invoked by second SOA 320. Thus, if a first message generated by second SOA 320 invokes Action 2, a message mapping system in accordance with the present technology determines that Operation2 is being invoked by second SOA 320. As a result, a second message can be generated which is sent to first SOA 310 and which invokes Operation2 rather than Action 2.

Upon determining the action of second SOA 320 being invoked, dynamic message mapping system 430 generates a second message 402 which is compatible with second SOA 320. In other words, second message 402 conforms to the message formatting which facilitates determining which action is being invoked by second SOA 320. For example, if Operation 1 is being requested by first SOA 310, second message 402 is generated in which Action 1 is invoked in a manner which is compatible with the message formatting used by second SOA 320 (e.g., in the SOAP header of second message 402). As discussed above, some SOAs utilize a communication system in which an invoked action is specifically conveyed within a SOAP message header. If the invoked action is not conveyed in this manner, the service receiving the message may not be able to determine which action is being invoked.

For example, the communication system used by second SOA 320 generates a proxy which appends the appropriate action being invoked to second message 402. In contrast, first SOA 310 may utilize a communication system which generates schema and port types that correspond to each method call. As a result, there is no direct way to determine which action(s) of second SOA 320 are being requested based upon a given schema/message type of first SOA 310. One solution may rely upon a static mapping of a specific port of first SOA 310 to a specific action of second SOA 320. This can be a problem as second SOA adds new methods. For example, additional ports of first SOA 310 might have to be configured to correlate to the additional methods.

However, using dynamic message mapping system 430, a correlation is established which facilitates determining which operation of action of second SOA 320 is being invoked by first SOA 310. In other words, dynamic message mapping system 430 detects the operation being invoked by first SOA 310 in the message context of message 401. The operation is then correlated with the corresponding action of second SOA 320 Thus, the static mapping of ports to invoked actions as described above can be avoided. Furthermore, because this mapping can be performed automatically, the user can forego manual configuration of dynamic message mapping system 430 in embodiments of the present technology. Additionally, if an action changes on a given service of second SOA 320, the mapping between an operation of first SOA 310 and second SOA 320 can be automatically updated to reflect the new correlations.

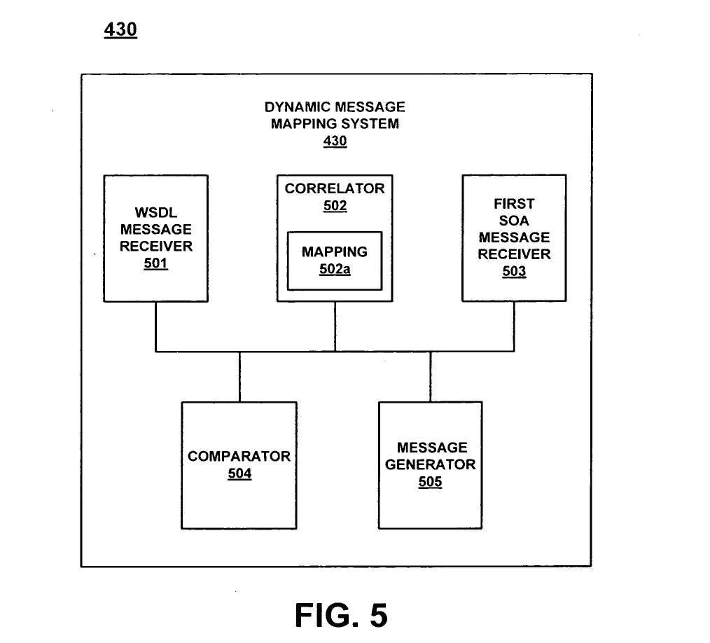

FIG. 5 is a block diagram of a dynamic message mapping system 430 in accordance with one embodiment of the present technology. In FIG. 5, dynamic message mapping system 430 comprises a WSDL message receiver 501. In one embodiment, when a service of second SOA 320 is exposed, the WSDL message which describes that service is received by WSDL message receiver 501.

Dynamic message mapping system 430 further comprises a correlator 502 for automatically generating a mapping 502a which correlates the action(s) of second SOA 320 which are exposed in a WSDL message with a corresponding operation of first SOA 310. Typically, mapping 502a is stored upon computer system 100 and is implemented as discussed above with reference to Sample Mapping 1. Correlator 502 is further for detecting the operation being invoked within the message context of first message 401.

Dynamic message mapping system 430 further comprises a first SOA message receiver 503 for receiving first message 401. Dynamic message mapping system 430 further comprises a comparator 504 for comparing an operation described in the message context of first message 401 with a corresponding action described in mapping 502a. Upon identifying the action of second SOA 320 which is being invoked by first SOA 310, comparator 504 sends this data to message generator 505.

Dynamic message mapping system 430 further comprises message generator 505 for generating second message 402 in a manner which is compatible with second SOA 320. In the present example, the invoked action is specified in metadata conveyed in the SOAP header of second message 402.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for dynamically mapping an action of a message, said computer-implemented method comprising:
receiving a first message generated by a first Service Oriented Architecture (SOA), said first message comprising an operation which is described within the message context of said first message;
determining that said operation corresponds to an action of a second SOA; and
generating a second message which is compatible with said second SOA, said second message comprising metadata describing said action of said second SOA.

2. The computer-implemented method as recited in claim 1 further comprising:
detecting said operation within the message context of said first message; and
correlating said operation with a specific port of said first SOA.

3. The computer-implemented method as recited in claim 2 further comprising:
selecting said specific port based upon said operation;
sending said first message from said specific port of said first SOA and wherein said first message is automatically appended with said operation.

4. The computer-implemented method as recited in claim 3 further comprising:
generating at least one Web Services Description Language (WSDL) message by said second SOA;
automatically generating a mapping which correlates said operation of said first SOA to said action of said second SOA based upon said at least one WSDL message; and
using said mapping to determine said action of said second SOA.

5. The computer-implemented method as recited in claim 4 further comprising:
correlating a plurality of operations of said first SOA with said action of said second SOA.

6. The computer-implemented method as recited in claim 1 further comprising:
generating said second message and wherein said second message is compliant with the Simple Object Access Protocol (SOAP).

7. The computer-implemented method as recited in claim 6 further comprising:
conveying said metadata in a header of said second message.

8. Instructions on a computer-usable medium wherein the instructions when executed cause a computer system to perform a method for dynamically mapping an action of a message, said computer-implemented method comprising:
receiving a first message generated by a first Service Oriented Architecture (SOA), said first message comprising an operation which is described within the message context of said first message;
determining that said operation corresponds to an action of a second SOA; and
generating a second message which is compatible with said second SOA, said second message comprising metadata describing said action of said second SOA.

9. The computer-usable medium as recited in claim 8 further comprising:
detecting said operation within the message context of said first message; and
correlating said operation with a specific port of said first SOA.

10. The computer-usable medium as recited in claim 9 further comprising;
selecting said specific port based upon said operation;
sending said first message from said specific port of said first SOA and wherein said first message is automatically appended with said operation.

11. The computer-usable medium as recited in claim 10 further comprising:
generating at least one Web Services Description Language (WSDL) message by said second SOA;
automatically generating a mapping which correlates said operation of said first SOA with said action of said second SOA based upon said at least one WSDL message; and
using said mapping to determine said action of said second SOA.

12. The computer-usable medium as recited in claim 11 further comprising:
correlating a plurality of operations of said first SOA with said action of said second SOA.

13. The computer-usable medium as recited in claim 8 further comprising:
generating said second message and wherein said second message is compliant with the Simple Object Access Protocol (SOAP).

14. The computer-usable medium as recited in claim 13 further comprising:
conveying said metadata in a header of said second message.

15. A dynamic message mapping system comprising:
a first Service Oriented Architecture (SOA) message receiver for receiving a first SOA message comprising an operation which is described within the message context of said first message;
a message comparator for determining that said operation corresponds to an action of a second SOA; and
a message generator for generating a second message which is compatible with said second SOA, said second message comprising metadata describing said action of said second SOA.

16. The dynamic message mapping system as recited in claim 15 wherein said operation is correlated with a specific port of said first SOA and wherein said operation is appended to said first message when said first message is sent via said specific port.

17. The dynamic message mapping system as recited in claim 15 further comprising:
a Web Services Description Language (WSDL) message receiver for receiving at least one WSDL message from said second SOA; and
a correlator for detecting said operation within the message context of said first SOA message and for automatically generating a mapping which correlates said operation of said first SOA with said action of said second SOA based upon said at least one WSDL message.

18. The dynamic message mapping system as recited in claim 17 wherein said message comparator determines that a plurality of operations of said first SOA correspond to said action of said second SOA.

19. The dynamic message mapping system as recited in claim 15 wherein said second message is compliant with the Simple Object Access Protocol (SOAP).

20. The dynamic message mapping system as recited in claim 19 wherein said message generator appends said action of said second SOA within the header of said second message.
